(19) United States
(12) Patent Application Publication
(10) Pub. No.: US 2001/0034666 A1
(43) Pub. Date: Oct. 25, 2001

(54) Method of providing repair information and doing business thereon on a global computer network

(76) Inventor: Robert Berliner, Sherman Oaks, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 09/764,530

(22) Filed: Jan. 17, 2001

Related U.S. Application Data
(60) Provisional application No. 60/176,899, filed on Jan. 18, 2000.

(51) Int. Cl. G06F 17/60

(52) U.S. Cl. 705/27; 705/14; 707/502

(57) ABSTRACT

A method of doing business on the world wide web, and an illustrated and documented web site, that provides information and resources for the repair of various devices where a user can mouse click on a particular illustrated part and have displayed on or more manufacturers and model numbers for the desired part and, with further click(s) can order the part from the manufacturer or from an after market supplier.

### CROSS-REFERENCE TO RELATED APPLICATIONS

This application claims an invention disclosed in U.S. Application Provisional Application Ser. No. 60/176,899, filed Jan. 18, 2000.

### FIELD OF THE INVENTION

The present invention is directed to a method for doing business on a global computer network, more particularly to the operation of a site on the world wide web whereby information about merchandise is displayed and information is provided on the purchase of the merchandise.

### BACKGROUND OF THE INVENTION

The global computer network, known variously as the world wide web or the Internet, provides unprecedented resources for information on virtually any subject. Among the information available, obtainable with search engines, are instructions for the maintenance and repair of a variety of devices such as home appliances. Other sites provide information about various items of merchandise that may be useful in such maintenance and repair. There is, however, no readily usable site which allows one to receive instructions about how to make particular repairs, while at the same time enabling one to purchase replacement parts needed to make the repair.

### SUMMARY OF THE INVENTION

The present invention provides a web site and method of doing business on a web site, constructed to enable a user to learn how to repair a wide variety of items, from small to large household appliances, to business machines such as typewriters, computers, printers and the like, to bicycle and automobiles, among a wide and diverse variety of devices and which facilitates the purchase of replacement parts for the repair. in particular, the invention provides an illustrated and documented web site that provides information and resources for the repair of various devices where a user can mouse click on a particular illustrated part and have displayed information about one or more manufacturers and/or model numbers for the desired part and, with further click(s) can order the part from the manufacturer or from an after market supplier and/or be directed to a web site of the manufacturer and/or other supplier of the part. The site can also include illustrations of tools and other repair supplies, e.g., hardware, plumbing, woodworking, -etc. tools; or books, pamphlets or magazine subscriptions on repair or on related matters, again enabling, with mouse clicks the display of manufacturers or sellers, and/or enabling the web site visitor to order desired items.

An embodiment of the invention provides a method of doing business on the world wide web, comprising: providing information on a web site about the repair of various devices wherein a user can click on displayed text or graphics representing a device needing repair, or part thereof needing repair or replacement, whereby information about one or more of the following items is made available to the user:(a) one or more manufacturers or other vendors of the device, (b) one or more models of the device, and (c) one or more parts selected by the user as needing repair or replacement; and deriving revenue from making one or more of said items of information available by one or more of the following activities: (a) direct sale of replacement devices or parts to the user, (b) obtaining referral fees or commissions from a manufacturer or other vendor of the device or part, or (c) gathering consumer information from the user's activities on the web site.

Another embodiment of the invention provides an internet web site, comprising: a plurality of web site pages providing information about the repair of various devices wherein a user can click on displayed text or graphics representing a device needing repair, or part thereof needing repair or replacement, whereby information about one or more of the following items is made available to the user:(a) one or more manufacturers or other vendors of the device, (b) one or more models of the device, and (c) one or more parts selected by the user as needing repair or replacement; and clickable regions on one or more of the web site pages enabling revenue to be derived from making one or more of said items of information available by one or more of the following activities: (a) direct sale of replacement devices or parts to the user, (b) obtaining referral fees or commissions from a manufacturer or other vendor of the device or part, or (c) gathering consumer information from the user's activities on the web site.

### BRIEF DESCRIPTION OF THE DRAWING

FIG. 1 is a page for use on a web site showing the repair of a small appliance, in this case, a garbage disposal, and showing operation of one aspect of the present invention.

### DETAILED DESCRIPTION OF THE PREFERRED EMBODIMENT

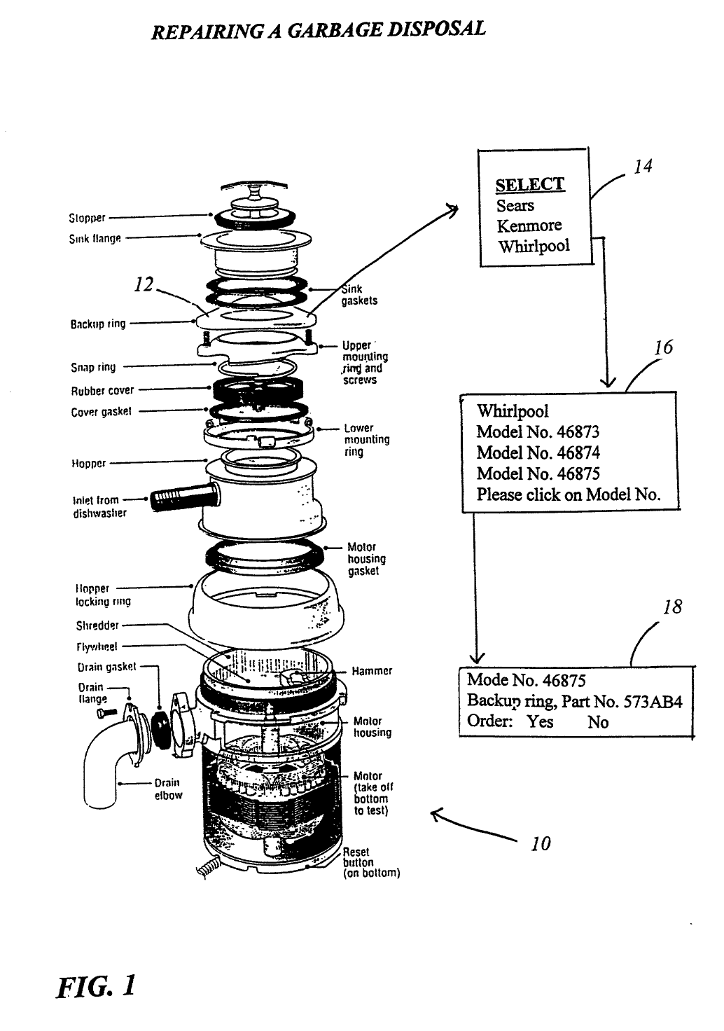

Referring to FIG. 1, a user who needs to repair a garbage disposal, can go to the web site which will have been advertised as providing repair information, or it can be found with an inquiry to a search engine. At the site, a list of devices for which repair information is available is presented. After navigating various pages pursuant to the list, the user arrives at a page where he or she can learn how to repair the device, in this case a garbage disposal 10. In accordance with this invention, by clicking on a component or part of the device that needs replacement, e.g., the backup ring 12, a pop-up window 14 is displayed showing information about the part. In one embodiment of the invention, as shown at 14, the names of various manufacturers are given. By clicking on the name of a particular manufacturer, another pop-up window 16 displays model numbers part numbers. By clicking on a model number, still another pop-up window 18 displays the part number and asks if the user wants to order the part. Clicking yes, brings the user to an order page where the manufacturer and part number are displayed together with a brief description of the part and its price. The user is then asked if he or she wants to complete the order or place the item in a “shopping cart” and return to the repair site. If the user wants to complete the order immediately, he or she the clicks on an order button, whereupon the user is taken to a secure order page where name, address, and credit card information are obtained in the usual manner, and shipping and handling information is also displayed.

The web site operator may keep the part in inventory, for example vacuum cleaner refill bags, tools and universal parts, or may drop ship them by prearrangement with various manufacturers or other sellers. The user will be given an order confirmation in the usual manner and be provided shipment times in accordance with the nature of the item.

If the user wants to return to the repair page, he or she can click on the instruction that send the item to the “shopping cart.” At the repair site, the user can click on other parts of the device to order other parts, as described above.

In another embodiment of the invention, when the user clicks on a part needing replacement, he or she is shown both the manufacturer's name and the model number of the device. Once the selection is made, the remaining information will be displayed as above, and operation will proceed as above, but limited to the part numbers of the particular manufacturer.

In still another embodiment of the invention, once the user has chosen the type of device for which he or she wants repair information, the user is given various manufacturers and model numbers from which to choose. After making a selection, what will be displayed in the pop-up window will be part number information only for that manufacturer's model number or numbers. As a further embodiment, if the user selects only the name of the manufacturer, all relevant model numbers will be displayed with appropriate part numbers. Alternatively, if the user only selects a model number, a search will ensue for manufacturers and those manufacturers with those model numbers will be displayed.

In another embodiment of the invention, at the outset, the user is asked to select the manufacturer from a pull down menu, either after choosing the type of device needing repair, the model numbers are displayed. Following selection of the model number, an illustration showing repair of that particular model is displayed. Such information in web page format (html, jpeg and/or gif) is initially obtained by the administrator of the web page from particular manufacturers.

In still another embodiment of the invention, the user is asked to select a manufacturer or other vendor, that has a web site, from a pull down menu or other list of manufacturers, or by entering information about the manufacturer in a search engine (such as all or part of the manufacturer's name, or the product name or type). The list can be limited to manufacturers who have a web site, or it can be indicated whether the manufacturer has one. Upon entering or finding the name of a manufacturer that has a web site, by clicking on the region of the screen that contains the manufacturer's name or any associated region, the user is sent to the manufacturer's web site, which is linked to this site, where he or she can look for or inquire about the device needing repair or replacement or a part thereof. The manufacturer's web site can be its home page, or a page containing repair or other information for that device, or a page prearranged to receive referrals from this web site.

In yet another embodiment of the invention, after the user selects the device, or part hereof, and manufacturer or other vendor that has a web site from a pull down menu or other list of manufacturers, or by entering information about the manufacturer in a search engine as above, by clicking on the region of the screen that contains the manufacturer's name or any associated region, the user is sent to the manufacturer's web site linked to this site, where he or she can look for or inquire about the device needing repair or replacement or a part thereof. In this embodiment, the manufacturer's web site can be its home page, a page containing repair or other information for that device or part, or a page prearranged to receive referrals from this web site.

Order information is then processed in accordance with the particular transaction. Where an inventory is kept, the order can be sent for internal processing. Where the part is to be supplied or drop shipped from a manufacturer, an order therefor can be relayed, by mail or, preferably, electronically, to the manufacturer, who will then fill it and rebate a referral fee to the web site owner. Fees for referrals or commissions can also be charged to manufacturers or other vendors who authorize or otherwise arrange or contract for them. Such fees can be correlated by referrals, which can be measured by any known procedure, such as by the click rate, or by actual links, or can depend on receipts from sales.

In addition to repair information, the site can also provide information about tools and supplies (e.g solder, glue, lumber, etc.), books and audio and/or video tapes about repairs and related matters.

The site can provide institutional advertising site for the publisher and can generate revenue inter alia by:

referral or commission income from manufacturers and suppliers, as above;

income from direct sale of repair related items, including the direct sale of supplies and hardware,, books, pamphlets, magazine subscriptions, or the like.

general advertising revenue.

gathering consumer information, such as the nature of appliances that users have made inquiries about, either as a group or individually, which can be used for consumer research purposes or for direct sales, or which can be leased or sold.

1. A method of doing business on the world wide web, comprising:
providing information on a web site about the repair of various devices wherein a user can click on displayed text or graphics representing a device needing repair, or part thereof needing repair or replacement, whereby information about one or more of the following items is made available to the user:(a) one or more manufacturers or other vendors of the device, (b) one or more models of the device, and (c) one or more parts selected by the user as needing repair or replacement; and
deriving revenue from making one or more of said items of information available by one or more of the following activities: (a) direct sale of replacement devices or parts to the user, (b) obtaining referral fees or commissions from a manufacturer or other vendor of the device or part, or (c) gathering consumer information from the user's activities on the web site.

2. The method of claim 1 wherein the displayed information is presented as a result of clicking on information about the device needing repair in the form of photographic or other illustration of the device or part.

3. The method of claim 2 wherein the information made available to the user is a list of manufacturers.

4. The method of claim 3 wherein the user can obtain information about the part needing repair or replacement by clicking one of the manufacturers in the list

5. The method of claim 4 wherein the user is directed to a web site of the manufacturer.

6. The method of claim 5 wherein the web site of the manufacturer is its site home page.

7. The method of claim 5 wherein the web site of the manufacturer is a site page on which information on the part is displayed.

8. The method of claim 6 wherein the web site of the manufacturer is a site page specifically set up to receive referrals from another web site and to compensate the owner of the referring web site.

9. The method of claim 1 wherein the displayed information is presented as a result of clicking on information of a part of the device needing repair or replacement in the form of photographic or other illustration of the part and information about one or more manufacturers or other vendors of the device part is displayed

10. The method of claim 9 wherein the user purchase the part needing repair or replacement by clicking one of the manufacturers in the list whereby the user is directed to an order page.

11. An internet web site, comprising:
a plurality of web site pages providing information about the repair of various devices wherein a user can click on displayed text or graphics representing a device needing repair, or part thereof needing repair or replacement, whereby information about one or more of the following items is made available to the user:(a) one or more manufacturers or other vendors of the device, (b) one or more models of the device, and (c) one or more parts selected by the user as needing repair or replacement; and
clickable regions on one or more of the web site pages enabling revenue to be derived from making one or more of said items of information available by one or more of the following activities: (a) direct sale of replacement devices or parts to the user, (b) obtaining referral fees or commissions from a manufacturer or other vendor of the device or part, or (c) gathering consumer information from the user's activities on the web site.

12. The web site of claim 11 wherein the displayed information is presented as a result of clicking on information about the device needing repair in the form of photographic or other illustration of the device or part.

13. The internet web site of claim 12 wherein the information made available to the user is a list of manufacturers enabling the user to obtain information about the part needing repair or replacement by clicking one of the manufacturers in the list

14. The internet web site of claim 12 wherein the information made available to the user is a list of manufacturers enabling the user to obtain information about the part needing repair or replacement by clicking one of the manufacturers in the list by being directed to a web site of the manufacturer.

15. The internet web site of claim 14 wherein the web site of the manufacturer is its site home page.

16. The internet web site of claim 14 wherein the web site of the manufacturer is a site page on which information on the part is displayed.

17. The internet web site of claim 15 wherein the web site of the manufacturer is a site page specifically set up to receive referrals from another web site and to compensate the owner of the referring web site.

18. The internet web site of claim 11 wherein the displayed information is presented as a result of clicking on information of a part of the device needing repair or replacement in the form of photographic or other illustration of the part and information about one or more manufacturers or other vendors of the device part is displayed, the user being able to purchase the part needing repair or replacement by clicking one of the manufacturers in the list whereby the user is directed to an order page.
